(19) United States
(12) Patent Application Publication
(10) Pub. No.: US 2023/0276742 A1
(43) Pub. Date: Sep. 7, 2023

(54) HORTICULTURE LIGHT AND GROW SYSTEM

(71) Applicant: Vigil Tech, Inc., Colorado Springs, CO (US)

(72) Inventor: John Martinez, Colorado Springs, CO (US)

(21) Appl. No.: 18/176,108

(22) Filed: Feb. 28, 2023

Related U.S. Application Data
(60) Provisional application No. 63/315,378, filed on Mar. 1, 2022.

(51) Int. Cl. A01G 7/04; H05B 47/16; H05B 47/155; H05B 47/165

(52) U.S. Cl. CPC A01G 7/045; H05B 47/155; H05B 47/16; H05B 47/165; A01G 9/249

(57) ABSTRACT

Various embodiments disclosed herein relate to horticulture lighting and control. In an embodiment, a method of operating a horticulture system includes, at a client device, establishing a connection to a recipe creation service, providing, to the recipe creation service, harvest data corresponding to a completed harvest cycle of a plant and comprising results and parameters of the completed harvest cycle, and providing, to the recipe creation service, inputs corresponding to an upcoming harvest cycle. The method also includes, at the recipe creation service, generating a grow recipe for the upcoming harvest cycle based on the harvest data and the inputs and providing the grow recipe to the client device. The method further includes, at the client device, providing the grow recipe to a mechanical grow apparatus comprising LED lights and a controller to control the LED lights for the upcoming harvest cycle based on the grow recipe.

### RELATED APPLICATIONS

This application claims the benefit of and priority to U.S. Pat. Application No. 63/315,378, filed Mar. 1, 2022, entitled “MODULAR HORTICULTURE LIGHT WITH MACHINE LEARNING GROW SYSTEM” which is hereby incorporated by reference in its entirety.

### TECHNICAL FIELD

This disclosure relates generally to horticulture lights, and control, design, and configurability thereof.

### BACKGROUND

Indoor horticultural activities have become increasingly popular over time. Indoor horticultural activities can take place in either greenhouses or in indoor grow facilities. In either case, additional, artificial lighting systems are often needed to supplement natural sunlight, if any, to grow plants indoors. Traditional horticulture lighting systems use metal halide lights. Most indoor grow facilities today utilize light emitting diode (LED) horticulture lighting. LEDs can produce light of various spectra to drive photosynthesis for indoor horticulture. However, LEDs, along with traditional, legacy solutions for horticulture activities fail to deliver light in all spectra present in natural sunlight necessary to trigger essential photomorphogenic and photophysiological processes in addition to photosynthesis.

In addition to lacking the ability to produce full light spectra, LED horticulture lighting also lacks controllability. For example, current LED systems utilize the LEDs at either full intensity (i.e., “on”) or at no intensity at all (i.e., “off”). Additionally, most LEDs used in these systems have fixed spectra. This means that when on, the LEDs produce light in only one spectra. However, the spectra of which sunlight is composed varies throughout the day, month, and year, so LED systems lack the ability to adjust spectra and intensity based on time and seasonal changes.

Another limitation of current horticulture lighting systems is the lack of feedback. This refers to light settings and other environmental conditions that created a successful harvest. Growers lack insight from such lighting systems, so they cannot compare data from one grow cycle against harvest results to ensure lighting and other conditions are repeated, or even improved, to perform further successful harvests.

### SUMMARY

Disclosed herein are improvements to horticulture lights, systems, and control thereof. In an example embodiment, a method of operating a horticulture system is provided. The method includes, at a client device, establishing a connection to a recipe creation service, providing, to the recipe creation service, harvest data corresponding to a completed harvest cycle of a plant and comprising results and parameters of the completed harvest cycle, and providing, to the recipe creation service, one or more inputs corresponding to an upcoming harvest cycle of the plant. The method also includes, at the recipe creation service, generating a grow recipe for the upcoming harvest cycle of the plant based on the harvest data and the one or more inputs and providing the grow recipe to the client device. The method further includes, at the client device, providing the grow recipe to a mechanical grow apparatus comprising LED lights and a controller, wherein the controller is configured to control the LED lights for the upcoming harvest cycle based on the grow recipe.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment for creating and implementing horticulture grow recipes in accordance with an embodiment.

FIG. 2 illustrates a series of steps for creating grow recipes and controlling horticulture lighting in accordance with an embodiment.

FIG. 3 illustrates an example operating architecture of a horticulture grow system in accordance with an embodiment.

FIGS. 4A and 4B illustrate example architectures of components of a grow recipe creation engine in accordance with an embodiment.

FIG. 5 illustrates example graphical representations of a horticulture system in accordance with an embodiment.

FIGS. 6A, 6B, 6C, 6D, and 6E illustrate example aspects of a horticulture light system and configurations thereof in accordance with an embodiment.

FIG. 7 illustrates an example configuration of a horticulture light system in accordance with an embodiment.

FIG. 8 illustrates an example heatsink component of a horticulture light system used in an embodiment.

FIG. 9 illustrates example configurations of a horticulture light system in accordance with an embodiment.

FIG. 10 illustrates example aspects of an LED board and a portion of a light structure in accordance with an embodiment.

FIG. 11 illustrates an example LED module and LED control system in accordance with an embodiment.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Various embodiments of the present technology relate to horticulture activities, and more specifically, to horticulture lighting and control thereof in indoor grow facilities. In indoor grow facilities, light emitting diode (LED) lighting is often used to help grow plants and crops due to a lack of natural sunlight in the facility. LED lights can produce light of various spectra to supplement any natural sunlight provided to plants. However, several problems remain with respect to LED lights for horticulture lighting.

First, existing LED horticulture lights only deliver Photosynthetically Active Radiation (PAR), which includes light of wavelengths from 400 nanometers to 700 nanometers. While these PAR-focused horticulture lighting solutions perform well driving photosynthesis for indoor horticulture, they fail to consider other photobiological processes beyond photosynthesis necessary for a successful harvest. Light in the Photobiologically Active Radiation (PBAR) range includes all the spectra present in natural sunlight including both Ultraviolet (UV) wavelengths as well as Infrared (IR) wavelengths. These non-PAR spectra alone, and in combination with PAR spectra, trigger essential photomorphogenic and photophysiological processes in addition to photosynthesis.

Secondly, LED horticulture lights lack controllability. As mentioned, existing LED horticulture lights are used at either full intensity or at no intensity and within only one spectra of light. However, plants and crops grow differently based on the time of day, month, and year, notwithstanding geographical considerations. Thus, these existing LED systems lack the ability to adjust spectra and intensity based on time and seasonal changes.

A third issue with LED lighting for horticulture activities is that the LEDs and components of LED systems are generally not replaceable in the event of failure. Accordingly, in cases of failures, growers must replace entire LED systems as opposed to replacing a lamp in more traditional metal halide and high-pressure sodium horticulture lights. This increases costs to growers and reduces modularity of a horticulture system given the expense of replacement LED lights.

Yet another limitation of LED lights in horticulture systems is the inability to direct illumination onto the plants. While a frame or components of an LED system can be directed to shine light towards the plants, once the frame is mounted, the LED lights themselves, or rows thereof, cannot be re-directed.

Lastly, existing horticulture lighting systems lack feedback mechanisms. In other words, horticulture lighting systems do not produce data or provide settings of the lights that were used to create a successful harvest. Consequently, growers cannot compare lighting data from one harvest cycle to another to repeat lighting conditions for further successful harvest cycles.

Advantageously, LED horticulture lighting apparatuses, systems, and services described herein can support controllable and directable LED lights that are able to provide light in the PBAR range according to a schedule optimized based on the plant, the time and season of the harvest, and the like. Accordingly, the improvements, processes, and techniques described herein alleviate issues present in existing horticulture lighting systems. These improvements not only reduce costs for growers by allowing for replaceable and modular LED lighting, but also they increase the likelihood of successful harvests by capturing data and inputs related to harvest cycles to generate lighting schedules for future harvests.

One example embodiment includes a method. The method includes, at a client device, establishing a connection to a recipe creation service, providing, to the recipe creation service, harvest data corresponding to a completed harvest cycle of a plant and including results and parameters of the completed harvest cycle, and providing, to the recipe creation service, one or more inputs corresponding to an upcoming harvest cycle of the plant. The method also includes, at the recipe creation service, generating a grow recipe for the upcoming harvest cycle of the plant based on the harvest data and the one or more inputs and providing the grow recipe to the client device. The method further includes, at the client device, providing the grow recipe to a mechanical grow apparatus comprising LED lights and a controller, wherein the controller is configured to control the LED lights for the upcoming harvest cycle based on the grow recipe.

In another example, a recipe creation service is provided that includes a harvest database, a recipe creation engine, and a provisioning engine. The harvest database stores harvest data corresponding to completed harvest cycles of plants. Harvest data refers to results and parameters of the completed harvest cycles. The recipe engine is configured to obtain the harvest data from the harvest database, obtain one or more inputs corresponding to an upcoming harvest cycle of a plant, and generate a grow recipe for the upcoming harvest cycle of the plant based on the harvest data and the inputs. The provisioning engine is configured to provide the grow recipe to a client device that controls operations of a mechanical grow apparatus having LED lights.

In yet another embodiment, a client device is provided. The client device has an interface, a memory, and a grow recipe execution engine. The interface functions to obtain, from a recipe creation service, a grow recipe for a harvest cycle of a plant and store the grow recipe on the memory. The grow recipe includes a lighting schedule including time intervals and channels of light spectra of LED lights of a mechanical grow apparatus. In the lighting schedule, one or more of the channels of the light spectra correspond to one or more time intervals of the time intervals. The grow recipe execution engine is configured to obtain the grow recipe from the memory and provide the grow recipe to the mechanical grow apparatus to perform the harvest cycle using the grow recipe.

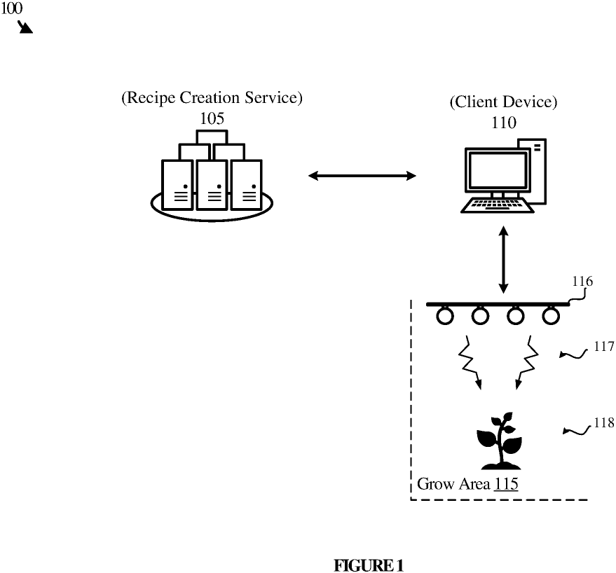

FIG. 1 illustrates an example operating environment for creating and implementing horticulture grow recipes in accordance with an embodiment. FIG. 1 shows operating environment 100, which includes recipe creation service 105, client device 110, and grow area 115.

Recipe creation service 105 is representative of a virtual computing element, such as a cloud platform, configured to perform horticulture grow operations as a service. Recipe creation service 105 can, additionally or alternatively, include various physical computing elements. For example, recipe creation service 105 can be implemented in one or more computing systems that include one or more servers, datacenters, databases, and the like. Recipe creation service 105 can further include communication elements to interface with one or more users and respective computing devices, such as client device 110, over a communication network.

Client device 110 is representative of a computing device or processing system capable of communicating with recipe creation service 105 over the communication network. Examples of client device 110 include a computer, tablet, laptop, smart phone, or the like. Client device 110 also interfaces with grow area 115 over a communication network.

Grow area 115 is representative of a horticulture area, such as a greenhouse, an indoor grow facility, or a portion thereof. In this example, grow area 115 includes horticulture light system 116 that emits light 117 on plant 118. While not shown, grow area 115 can include additional lighting systems and plants, among other components. For example, grow area 115 may also include soil, water, carbon dioxide (CO₂), and several other environmental and artificial elements (not shown).

Horticulture light system 116 is representative of a grow apparatus that may include a plurality of lights, such as LEDs, attached to one or more frames. The LEDs may be powered by a power supply and controlled by a controller. The LEDs can emit light 117 of various channels of light spectra. The channels of light spectra include an ultraviolet-A (UV-A) channel (e.g., between 315 and 400 nanometers (nm)), an ultraviolet-B (UV-B) channel (e.g., between 280 and 315 nm), a photosynthetically active radiation (PAR) channel (e.g., between 400 and 700 nm), a deep-red channel (e.g., between 660 and 670 nm), and a far-red channel (e.g., between 720 and 730 nm). In various embodiments, these channels may be electrically isolated from one another, such that each channel can be controlled independently from other channels. Plant 118 can capture the energy provided by the LED lights of horticulture light system 115 to grow and complete a harvest cycle. A harvest cycle refers to the lifecycle of plant 118 from initial planting through full growth of plant 118.

Communication between recipe creation service 105 and client device 110 and communication between client device 110 and components of grow area 115 may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

In operation, client device 110 establishes a connection to recipe creation service 105 over the communication network. Once connected, client device 110 can provide, over the communication network, harvest data associated with a completed harvest cycle of plant 118. The harvest data can include results of the completed harvest cycle and parameters of the completed harvest cycle. The results may indicate produced outcomes from the harvest of plant 118. For example, the results can demonstrate a potency of plant 118, a size and weight of plant 118, and a flavor of plant 118, among other characteristics and outcomes. In some cases, the results are embodied in lab-certified documentation, such as a Certificate of Authenticity (CoA). The parameters included in the harvest data may indicate environmental and artificial parameters set or present during the completed harvest cycle. For example, environmental parameters may include the type of soil used during the harvest cycle, an amount of natural sunlight plant 118 was exposed to during the harvest cycle, an amount of CO₂ plant 118 was exposed to during the harvest cycle, and the like. Artificial parameters may include light settings of horticulture light system 116, such as intensity, light spectra, and the like used during the harvest cycle, duration of light exposure on plant 118 from horticulture light system 116, a distance between horticulture light system 116 and plant 118, and a temperature inside the horticulture site, among other parameters.

In addition to the harvest data, client device 110 can also provide one or more inputs to recipe creation service 105. The inputs may indicate parameters, preferences, and goals for an upcoming harvest cycle of plant 118 (i.e., a subsequent harvest following the completion of a first harvest). In other words, such inputs may be representative of desired outcomes of a new harvest cycle of a plant of the same type or species of plant 118. For example, the inputs may include a desired potency, size, weight, and flavor, among other outcomes.

Recipe creation service 105 obtains the harvest data and the inputs from client device 110 and generates a grow recipe for the upcoming harvest cycle of plant 118 based on the harvest data and the inputs. To do so, recipe creation service 105 may include a grow recipe creation engine (e.g., a machine learning model) trained to ingest the harvest data and inputs and generate the grow recipe. For example, the grow recipe creation engine may identify parameters from the completed harvest cycle that can be repeated or that can be changed to meet desired outcomes in the inputs. Additionally, the grow recipe creation engine can identify characteristics and needs of plant 118, such as the daily photosynthesis period of plant 118, the daily light integral of plant 118, and the type of plant 118 to tailor the grow recipe specifically to plant 118.

The grow recipe produced by recipe creation service 105 can include a lighting schedule by which to operate horticulture light system 116 to achieve the desired outcomes (e.g., growth) of plant 118. The lighting schedule can include time intervals (e.g., hours, minutes) and intensities and channels of the light spectra of the LED lights corresponding to individual ones of the time intervals. By way of example, the grow recipe may specify that for a duration in the morning, horticulture light system 116 should provide light 117 at full intensity at the UV-A channel. For a duration in the afternoon, the grow recipe may specify that horticulture light system 116 should provide light 117 at full intensity at the PAR and deep-red channels. Further, for an evening time interval, the grow recipe may specify that horticulture light system 116 should provide light 117 at a lesser-than-full intensity at the deep-red channel. It may be appreciated that any combination and variation of times, intensities, and spectra can be used in a grow recipe for any type of plant 118.

Recipe creation service 105 can then provide the grow recipe to client device 110 and client device 110 can provide the grow recipe to horticulture light system 116. In various embodiments, horticulture light system 116 has a controller configured to operate the LED lights and power supply, among other components, according to the grow recipe. In some embodiments, horticulture light system 116 may also include a memory capable of storing the grow recipe. In such cases, the controller of horticulture light system 116 can execute the grow recipe from the local memory of horticulture light system 116 to operate accordingly. In other embodiments, the controller of horticulture light system 116 may execute the grow recipe from a memory of client device 110. Regardless, horticulture light system 116 can emit light 117 according to the grow recipe throughout the upcoming harvest cycle of plant 118.

It may be appreciated that the grow recipe may also include other insights and schedules in addition to the lighting schedule. For example, the grow recipe may include a watering schedule, an air flow and ventilation schedule, a temperature schedule, a CO₂ schedule, and the like. Similar to the lighting schedules, these other schedules can provide recommended settings and corresponding time intervals at which to operate other horticulture, agriculture, and HVAC systems (not shown) to achieve the desired outcomes of the harvest cycle. It follows that client device 110 can distribute the grow recipe to each additional system so the systems can perform according to the grow recipe.

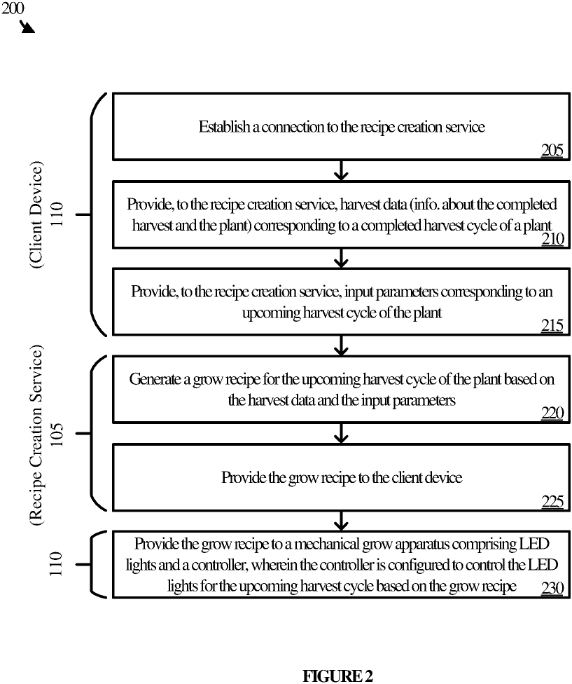

FIG. 2 illustrates a series of steps for creating horticulture grow recipes and controlling horticulture lighting. FIG. 2 includes process 200 described parenthetically below, which references elements of FIG. 1. Process 200 can be implemented by components of a horticulture system, such as recipe creation service 105 and client device 110 of FIG. 1.

In operation 205, client device 110 establishes (205) a connection to recipe creation service 105. In various embodiments, recipe creation service 105 can be hosted on a cloud platform. In such cases, establishing a connection may entail establishing a link between client device 110 and recipe creation service 105 over the Internet via an application programming interface (API). In other embodiments, recipe creation service 105 can be a software program accessible locally by client device 110.

Next in operation 210, client device 110 provides (210) harvest data corresponding to a completed harvest cycle of plant 118 to recipe creation service 105. The harvest data can include results of the completed harvest cycle and parameters of the completed harvest cycle. The results may indicate produced outcomes from the harvest of plant 118. For example, the results can demonstrate a potency of plant 118, a size and weight of plant 118, and a flavor of plant 118, among other characteristics and outcomes. The parameters included in the harvest data may indicate environmental and artificial parameters set or present during the completed harvest cycle. For example, environmental parameters may include the type of soil used during the harvest cycle, an amount of natural sunlight plant 118 was exposed to during the harvest cycle, an amount of CO₂ plant 118 was exposed to during the harvest cycle, and the like. Artificial parameters may include light settings of horticulture light system 116, such as intensity, light spectra, and the like used during the harvest cycle, duration of light exposure on plant 118 from horticulture light system 116, a distance between horticulture light system 116 and plant 118, and a temperature inside the horticulture site, among other parameters.

In operation 215, client device 110 provides (215) input parameters corresponding to an upcoming harvest cycle of plant 118 to recipe creation service 105. The input parameters may indicate settings and goals for the upcoming harvest cycle of plant 118 (i.e., a subsequent harvest following the completion of a first harvest). In other words, such inputs may be representative of desired outcomes of a new harvest cycle of a plant of the same type or species of plant 118. For example, the inputs may include a desired potency, size, weight, and flavor, among other outcomes.

In operation 220, recipe creation service 105 generates (220) a grow recipe for the upcoming harvest cycle of plant 118 based on the harvest data and the input parameters. To generate the grow recipe, recipe creation service 105 may include a grow recipe creation engine (e.g., a machine learning model) trained to ingest the harvest data and inputs and generate the grow recipe. For example, the grow recipe creation engine may identify parameters from the completed harvest cycle that can be repeated or that can be changed to meet desired outcomes in the inputs. Additionally, the grow recipe creation engine can identify characteristics and needs of plant 118, such as the daily photosynthesis period of plant 118, the daily light integral of plant 118, and the type of plant 118 to tailor the grow recipe specifically to plant 118.

The grow recipe produced by recipe creation service 105 can include a lighting schedule by which to operate horticulture light system 116 to achieve the desired outcomes (e.g., growth) of plant 118. The lighting schedule can include time intervals (e.g., hours, minutes) and intensities and channels of the light spectra of the LED lights corresponding to individual ones of the time intervals. By way of example, the grow recipe may specify that for a duration in the morning, horticulture light system 116 should provide light 117 at full intensity at the UV-A channel. For a duration in the afternoon, the grow recipe may specify that horticulture light system 116 should provide light 117 at full intensity at the PAR and deep-red channels. Further, for an evening time interval, the grow recipe may specify that horticulture light system 116 should provide light 117 at a lesser-than-full intensity at the deep-red channel. It may be appreciated that any combination and variation of times, intensities, and spectra can be used in a grow recipe for any type of plant 118.

Then, in operation 225, recipe creation service 105 can provide (225) the grow recipe to client device 110 over the established communication network. Client device 110 can then, in operation 230, provide (230) the grow recipe to horticulture light system 116 over a different communication link. Horticulture light system 116, via a controller onboard the mechanical lighting apparatus, can control operations of the LED lights and power supply, among other components of horticulture light system 116, according to the grow recipe. This may entail controlling the emissions (spectra and intensity) of light 117 per the lighting schedule of the grow recipe.

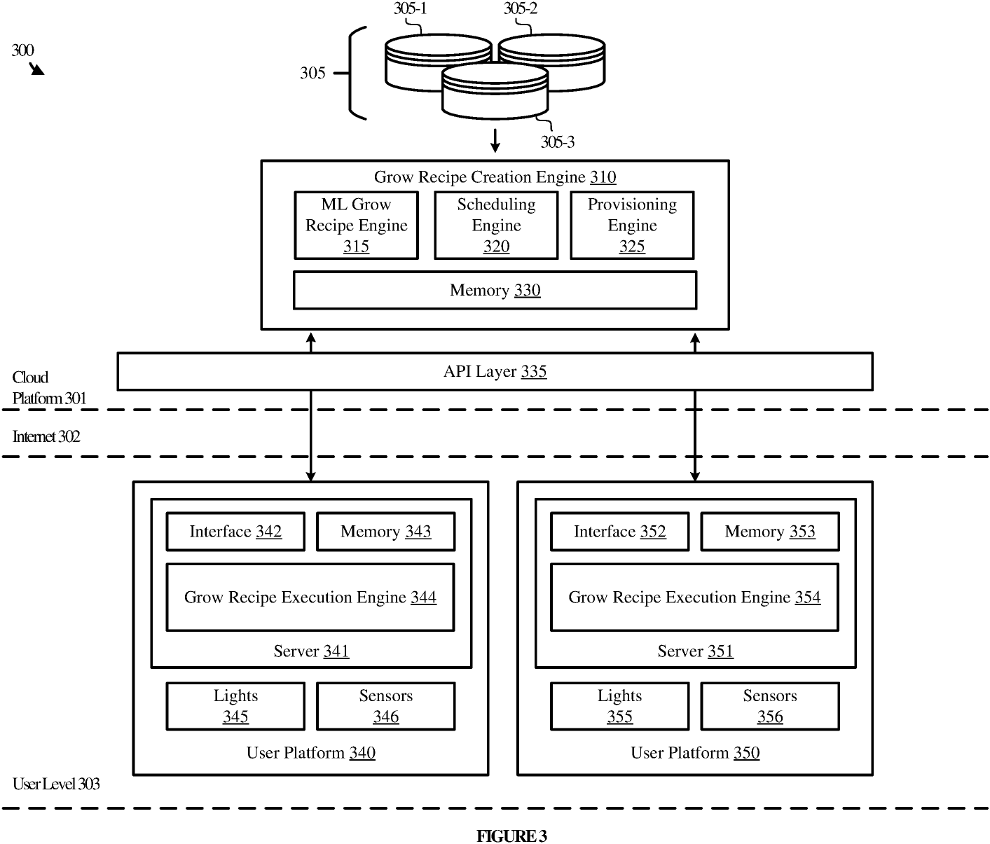

FIG. 3 illustrates an example operating architecture of a horticulture grow system in accordance with an embodiment. FIG. 3 shows operating architecture 300, which includes various components operating on cloud platform 301, internet 302, and user level 303. Operating architecture 300 includes databases 305, grow recipe creation engine 310, application programming interface (API) layer 335, and user platforms 340 and 350. For example, operating architecture 300 represents an architecture of components of operating environment 100 of FIG. 1.

Cloud platform 301 is representative of one or more servers or datacenters operating virtually with respect to one or more user devices. Cloud platform 301 can host databases 305 for data storage and grow recipe creation engine 310 for horticulture recipe creation service, among other services, which can be accessed by user devices located remotely from cloud platform 301 via a communication network. For example, user platforms 340 and 350 of user level 303 can access, communicate with, and upload/download data with elements of cloud platform 301 via internet 302 via API layer 335. It may be appreciated that the architecture and elements of cloud platform 301 may be implemented in recipe creation service 105 of FIG. 1 and can execute at least part of process 200 of FIG. 2.

Cloud platform 301 includes harvest cycle database 305-1, sensor data database 305-2, and settings database 305-3, collectively referred to herein as databases 305. Each of databases 305 can store data related to harvest cycles of a plant and equipment used in the performance of the harvest cycles. For example, harvest cycle database 305-1 may include harvest data corresponding to one or more completed harvest cycles of a plant, which may include results (e.g., lab-certified results, certificates of authenticity, other documented results) of the completed harvest cycle. The results may indicate produced outcomes from the harvest of the plant. For example, the results can demonstrate a potency, a size and weight, and a flavor of the harvested plant, among other characteristics and outcomes. Sensor data database 305-2 can store parameters related to the harvest cycles of the plant and sensor data captured by sensors of equipment used in the horticulture grow area. For example, sensor data database 305-2 can include environmental parameters such as the type of soil used during the harvest cycle, an amount of natural sunlight the plant was exposed to during the harvest cycle, an amount of CO₂ the plant was exposed to during the harvest cycle, the temperatures the plant was exposed to during the harvest cycle, the barometric pressure, or other air characteristics, the plant was exposed to during the harvest cycle, and the like. Settings database 305-3 can store settings and parameters of equipment used for the harvest cycle. For example, settings database 305-3 can include artificial parameters, such as light settings of a horticulture light system (e.g., intensity, light spectra) used during the harvest cycle, duration of light exposure on the plant from the horticulture light system, and a distance between the horticulture light system and the plant, among other settings.

Cloud platform 301 also includes grow recipe creation engine 310. Grow recipe creation engine 310 is representative of one or more virtual or physical computing elements configured to obtain data from databases 305, store such data on memory 330, and generate horticulture grow recipes for use by a horticulture grow system and components thereof. Grow recipe creation engine 310 includes machine learning (ML) grow recipe engine 315, scheduling engine 320, provisioning engine 325, and memory 330.

Memory 330, among other memories discussed herein, may be any computer-readable storage media device capable of being read from and written to by ML grow recipe engine 315, scheduling engine 320, and provisioning engine 325. Memory 330 may include volatile and nonvolatile, removable and non-removable media implemented in any method of technology for storage of information. For example, memory 115 may include random access memory (RAM), static RAM (SRAM), dynamic RAM (DRAM), double data rate (DDR), flash memory, tightly coupled memory (TCM), or any other type of memory or combination or variation thereof. Memory 330 is shown as a single memory device but may be implemented as one or more memory devices and may include device(s) for storing software and firmware. Memory 330 is not a transitory signal in any embodiment. Memory 330 may be implemented separately or in an integrated manner with respect to other types of memory.

ML grow recipe engine 315 is representative of a machine learning model (e.g., a neural network) trained to generate a grow recipe for a harvest cycle of a plant based on one or more inputs from a user and data of databases 305. A user operating user platform 340, for example, can supply the one or more inputs to ML grow recipe engine 315. These inputs may indicate settings and goals for an upcoming harvest cycle of a plant. For example, the inputs may include a desired potency, size, weight, and flavor, among other outcomes. ML grow recipe engine 315 can then supply the inputs through one or more layers (e.g., convolution layers) to generate a grow recipe. The grow recipe produced by ML grow recipe engine 315 can include a lighting schedule by which to operate a horticulture light system of a grow area to achieve the desired outcomes (e.g., growth) of the harvest cycle. The lighting schedule can include time intervals (e.g., hours, minutes) and intensities and channels of the light spectra of the LED lights corresponding to individual ones of the time intervals. The generated grow recipe can be stored in memory 330 for use by other components of grow recipe creation engine 310.

Scheduling engine 320 is included to configure the grow recipe for implementation by a horticulture light system. For example, scheduling engine 320 may obtain information about the horticulture light system (e.g., operating specifications of the lights, LED driver specifications) and configure the grow recipe to a format useable by the horticulture light system.

Provisioning engine 325 is included to provide grow recipes to one or more users of user level 303. For example, provisioning engine 325 can provide one grow recipe to multiple different users, one grow recipe to one user and a different grow recipe to another user, or any combination or variation thereof. Provisioning engine 325 may communicate the grow recipe(s) to users of level 303 via API layer 335, which communicates data to and from cloud platform 301 and user level 303 over internet 302.

Internet 302 is representative of a communication network or networks operating in accordance with various communication protocols, combinations of protocols, or variations thereof. For example, internet 302 may exemplify intranets, internets, the Internet, local area networks, wide area networks, wireless networks, wired networks, virtual networks, software defined networks, data center buses and backplanes, or any other type of network, combination of network, or variation thereof.

User level 303 is representative of one or more physical or virtual elements operating among each other in a different network with respect to cloud platform 301. For example, user level 303 may include elements located at one or more horticulture grow areas, such as indoor grow facilities or greenhouses. User level 303 includes user platforms 340 and 350. User platforms 340 and 350 demonstrate an example architecture of a client device used in recipe creation processes, such as client device 110 of FIG. 1. Further, user platforms 340 and 350 can operate a part of process 200 of FIG. 2.

User platform 340 includes server 341, lights 345, and sensors 346. Similarly, user platforms 350 includes server 351, lights 355, and sensors 356. In some instances, user platforms 340 and 350 operate at the same horticulture grow facility, however, in other instances, user platforms 340 and 350 operate at different horticulture grow facilities. Regardless, user platforms 340 and 350 may be configured to implement grow recipes for individual ones of horticulture light systems (e.g., horticulture light system 116 of FIG. 1). To do so, user platforms 340 and 350 include servers 341 and 351, respectively, that include one or more processors or computing elements configurable to obtain grow recipes from grow recipe creation engine 310 and provide the grow recipes to horticulture light systems for execution by a controller of horticulture light systems to control lights 345 and 355, respectively, for example.

Servers 341 and 351 include interfaces 342 and 352, memories 343 and 353, and grow recipe execution engines 344 and 354, respectively. Interfaces 342 and 352 are included to provide two-way communication between user platforms 340 and 350, respectively, and grow recipe creation engine 310 via API layer 335. Memories 343 and 353 are included to store data from sensors 346 and 356, respectively, and the grow recipes provided by provisioning engine 325, among other data and instructions. Grow recipe creation engines 344 and 354 function to provide the grow recipes to respective horticulture light systems.

By way of example, the horticulture light systems described herein may include mechanical frames, a power supply, LED lights (e.g., lights 345 and 355), and a controller to control operations of the horticulture light system. The controller may include hardware, software, and/or firmware configured to execute instructions of the grow recipe and control LED lights according to the grow recipe. It follows that lights 345 and 355 include LED lights onboard a horticulture light system. Lights 345 and 355 can emit light of various channels of light spectra. The channels of light spectra include an ultraviolet-A (UV-A) channel, an ultraviolet-B (UV-B) channel, a photosynthetically active radiation (PAR) channel, a deep-red channel, and a far-red channel. When a grow recipe is executed by a controller of a horticulture light system, the intensity of emissions and light spectra can be controlled according to the grow recipe.

During and following a harvest cycle whereby the grow recipe is implemented by a horticulture light system, sensors 346 and 356 can capture harvest data, light settings, and the like. Servers 341 and 351 can provide such sensor data to one or more of databases 305, which can further be used to refine and/or create new grow recipes. Moreover, the data captured by sensors 346 and 356 can cause grow recipe execution engines 344 and 354, respectively, to adjust an implemented grow recipe in real-time. For example, sensors 346 and 356 may include a far-red light sensor. During a day of a harvest cycle, the far-red light sensor may provide data related red/far-red ratios of natural sunlight available that day. Based on the captured ratios, grow recipe execution engines 344 and 354 can adjust lights 345 and 355, respectively.

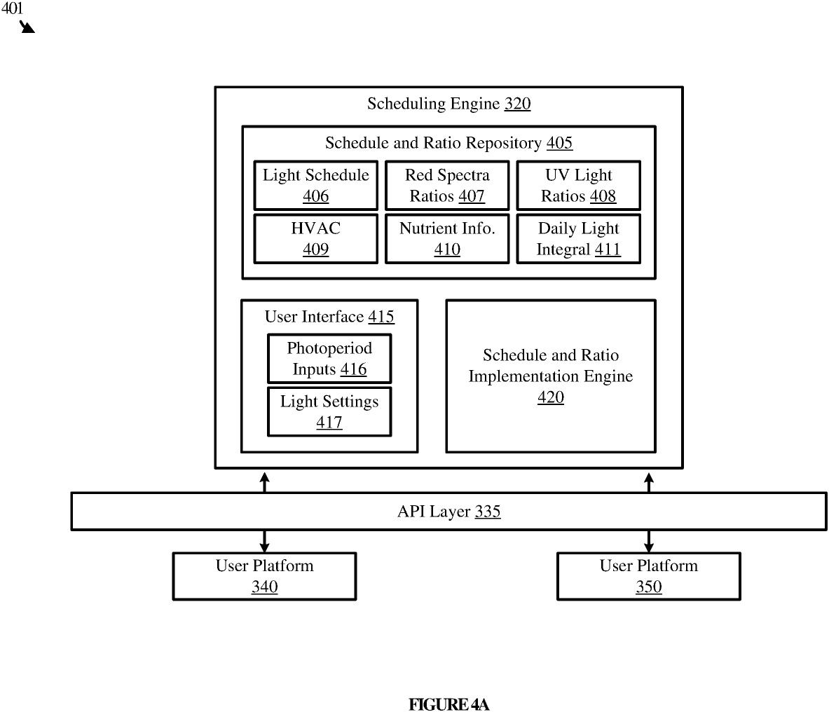

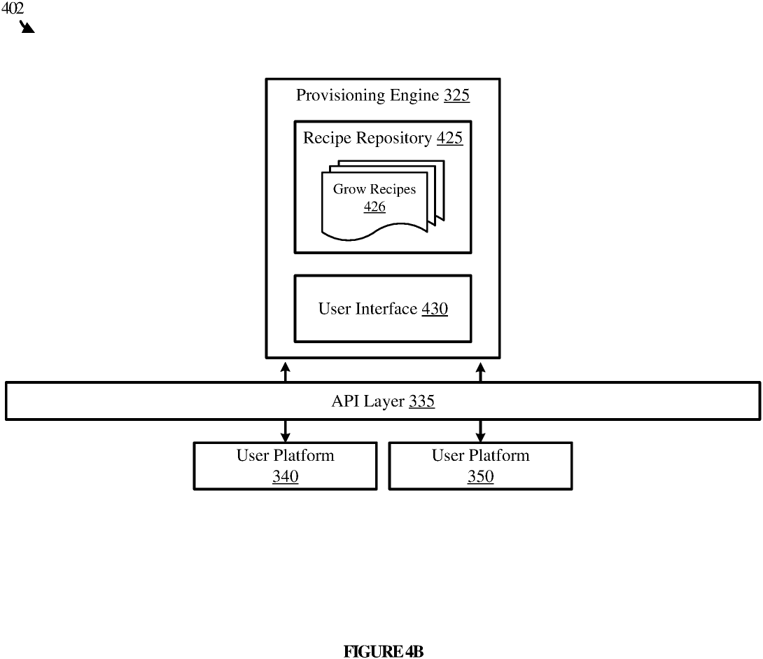

FIGS. 4A and 4B illustrate example architectures of components of a grow recipe creation engine in accordance with an embodiment. FIGS. 4A and 4B demonstrate architectures 401 and 402, respectively, which refer to some elements of operating architecture 300 of FIG. 3. Architecture 401 includes scheduling engine 320 and components thereof. Architecture 402 includes provisioning engine 325 and components thereof.

Referring first to FIG. 4A, operating architecture 401 may demonstrate an example architecture of scheduling engine 320 of FIG. 3. Scheduling engine 320 includes schedule and ratio repository 405, user interface 415, and schedule and ratio implementation engine 420.

Schedule and ratio repository 405 is representative of a memory element of scheduling engine 320 that stores data related to light settings of a generated grow recipe created by ML grow recipe engine 315 (not shown). Schedule and ratio repository 405 includes light schedule 406, red spectra ratios 407, UV light ratios 408, HVAC 409, nutrient information 410, and daily light integral 411. Light schedule 406 may include the lighting schedule of the grow recipe. This may further include the time intervals and the light spectra of each time interval by which to operate lights of a horticulture light system. Red spectra ratios 407 includes calculated ratios between the deep-red light channel and the far-red light channel with respect to time intervals of the lighting schedule. UV light ratios 408 includes calculated ratios between the UV-A and UV-B light channels with respect to time intervals of the lighting schedule. In other words, red spectra ratios 407 and UV light ratios 408 identify how much deep-red light a plant should receive compared to far-red light and how much UV-A light a plant should receive compared to UV-B light, respectively. HVAC 409 may include air flow, air temperature, air quality, and other air parameters to be used in the grow recipe for the harvest cycle. Nutrient information 410 may include nutritional needs of the plant during the harvest cycle. For example, nutrient information 410 may indicate a type of soil, an amount of fertilizer, and an amount of water that should be provided to the plant during the harvest cycle according to the grow recipe. Daily light integral 411 may indicate the number of photosynthetically active photons needed to be delivered daily to the plant during the harvest cycle according to the grow recipe.

User interface 415 is representative of an interface that can be used for communication between scheduling engine 320 and client devices, such as user platforms 340 and 350. User interface 415 may include a graphical user interface to scheduling engine 320. In other cases, user interface 415 may include a communication link configured to receive inputs from a graphical user interface to the client devices communicating with scheduling engine 320 (via API layer 335). Regardless, user interface 415 can obtain photoperiod inputs 416 and light settings 417. Photoperiod inputs 416 may include information about the plant, such as the daily light integral 411 of the plant. Accordingly, this input may be stored in schedule and ratio repository 405. Light settings 417 may include information about the lights (e.g., lights 345 and 355 of FIG. 3), which can be used to configure and implement the light schedule 406, red spectra ratios 407, and UV light ratios 408, for example.

Schedule and ratio implementation engine 420 is included to configure the grow recipe for implementation by a horticulture light system. For example, schedule and ratio implementation 420 is configured to obtain information from schedule and ratio repository 405 and user interface 415, update the grow recipe according to the information and inputs, and provide the grow recipe to a provisioning engine (not shown), such as provisioning engine 325 of FIG. 3.

Referring next to FIG. 4B, FIG. 4B shows operating environment 402. Operating environment 402 may demonstrate an example architecture of provisioning engine 325 of FIG. 3. Provisioning engine 325 includes recipe repository 425 and user interface 430.

Recipe repository 425 is representative of a memory element of provisioning engine 325 that stores grow recipes created by ML grow recipe engine 315 (not shown). Recipe repository 425 includes grow recipes 426. Grow recipes 426 include one or more grow recipes created by ML grow recipe engine 315 and configured by scheduling engine 320 (not shown).

User interface 430 is representative of an interface that can be used for communication between provisioning engine 325 and client devices, such as user platforms 340 and 350. User interface 430 may include a graphical user interface to provisioning engine 325. In other cases, user interface 430 may include a communication link configured to receive inputs from a graphical user interface to the client devices communicating with provisioning engine 325 (via API layer 335). Regardless, user interface 430 can obtain inputs from a client device, such as a selection of a grow recipe. For example, user platform 340 can, via API layer 335, request a grow recipe from provisioning engine 325 using user interface 430. Then, provisioning engine 325 can obtain the requested grow recipe from recipe repository 425 and provide the grow recipe to user platform 340 for implementation.

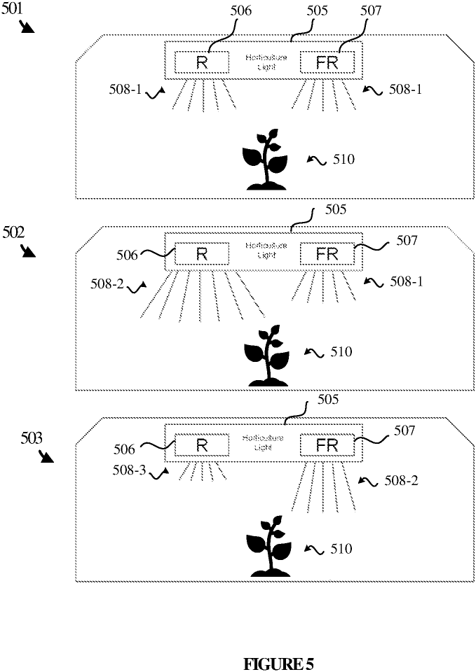

FIG. 5 illustrates example graphical representations of a horticulture system in accordance with an embodiment. FIG. 5 demonstrates aspects 501, 502, and 503, each aspect depicting a horticulture light 505 configurable to emit light at various intensities and spectra.

Each of aspects 501, 502, and 503 include horticulture light 505, red light 506, far red light 507, and plant 510. Red light 506 and far red light 507 each emit light in one or more of the red channels of light spectra. For instance, red light 506 can emit red light in the PAR channel and the deep-red channel, while far red light 507 can emit light in the far-red channel. Red light 506 and far red light 507 emit such light at varying intensity 508. As illustrated, aspect 501 demonstrates that red light 506 and far red light 507 emit light at intensity 508-1 toward plant 510. In aspect 502, a grow recipe may cause horticulture light 505 to change the intensity of red light 506 to a stronger intensity than intensity 508-1, such as intensity 508-2. This may be because the grow recipe may identify a red spectra ratio that causes horticulture light 505 to produce more light in the deep-red channel than light in the far red channel. In aspect 503, a grow recipe may cause horticulture light 505 to change the intensity of red light 506 to a weaker intensity than intensity 508-1 and 508-2, such as intensity 508-3. This may be because the grow recipe may identify a red spectra ratio that causes horticulture light 505 to produce more light in the far red channel than light in the far red channel. It may be appreciated that horticulture light 505 can produce any combination or variation of light spectra channels (i.e., other light channels not shown) and intensities based on a grow recipe.

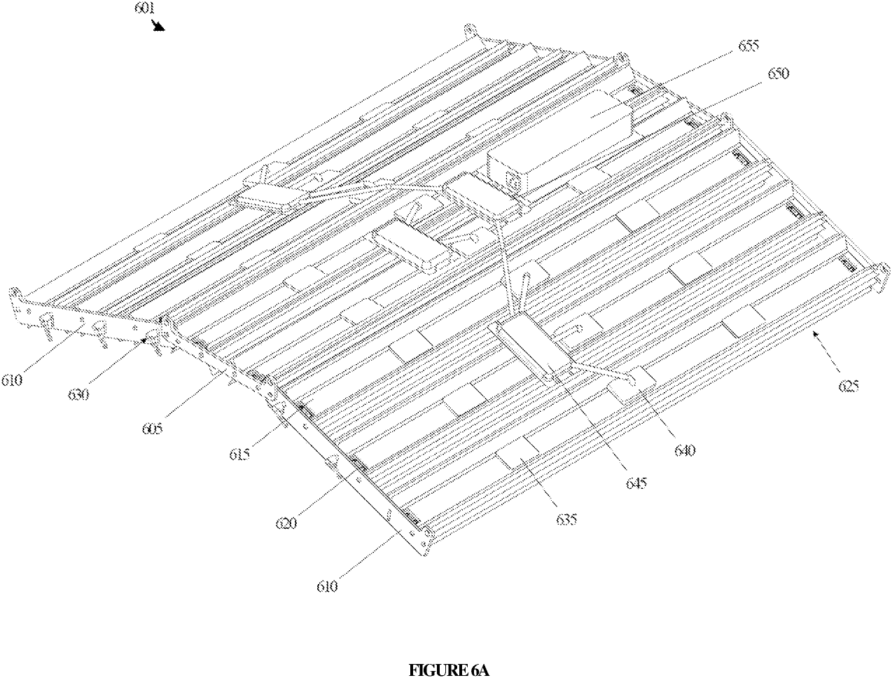

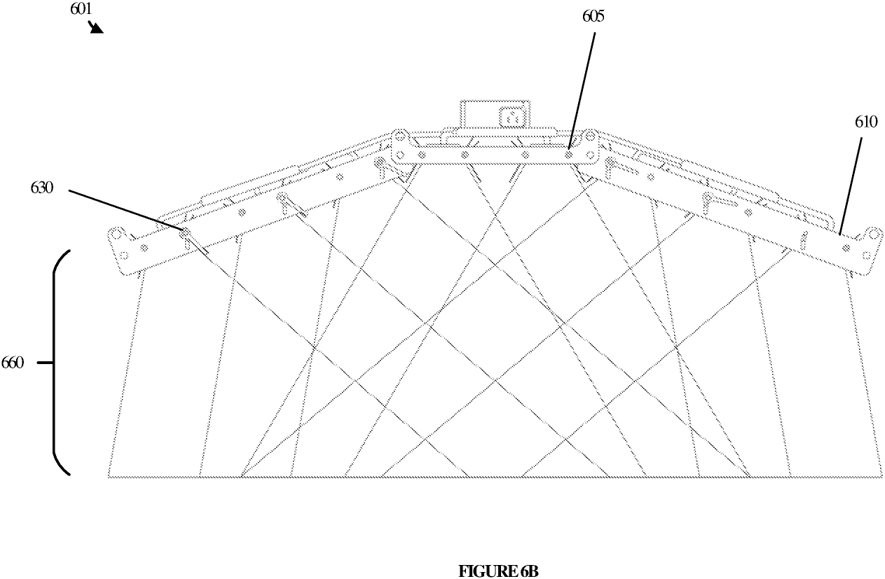

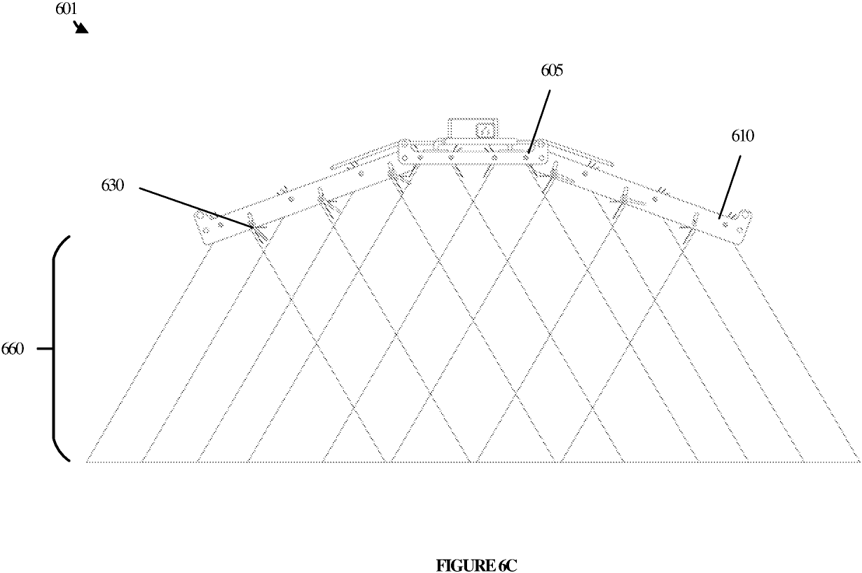

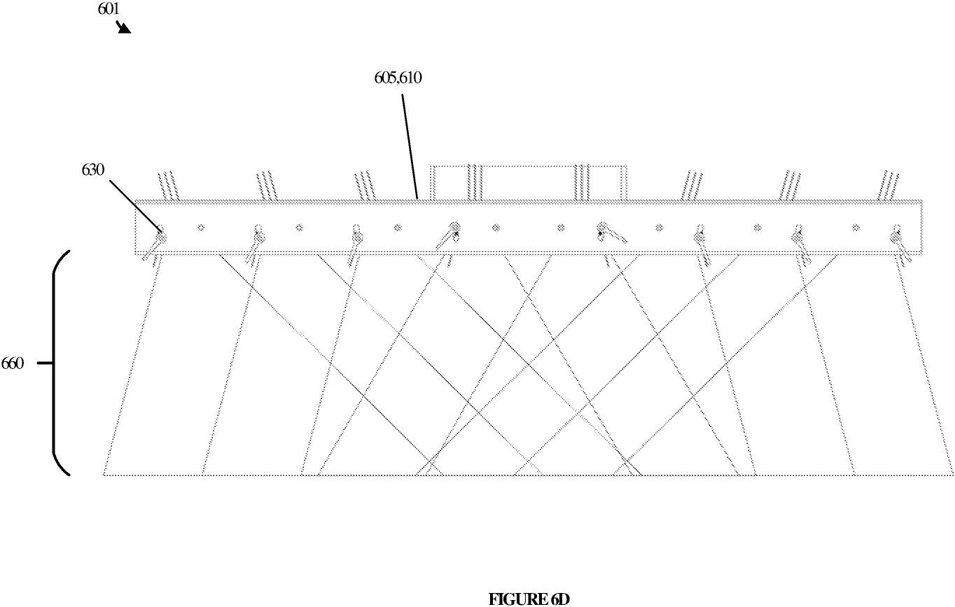

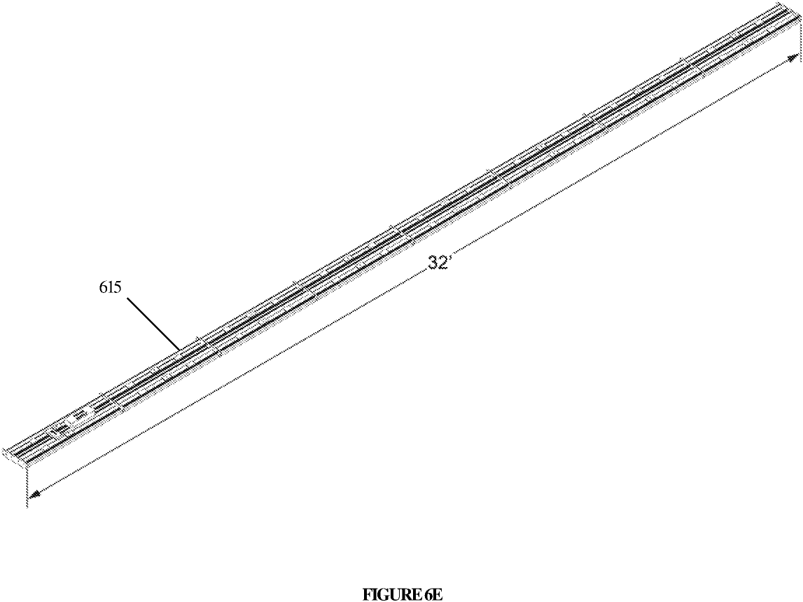

FIGS. 6A, 6B, 6C, 6D, and 6E illustrate example aspects of a horticulture light system 601 and configurations thereof in accordance with an embodiment. FIG. 6A illustrates a top-side, isometric view of horticulture light system 601. FIG. 6B illustrates a side view of horticulture light system 601. FIG. 6C illustrates a side view of horticulture light system 601. FIG. 6D also illustrates a side view of horticulture light system 601. FIG. 6E illustrates a configurable component of horticulture light system 601. Horticulture light system 601 may be used in various embodiments, such as in operating environment 100 of FIG. 1 and aspects 501-503 of FIG. 5.

Referring first to FIG. 6A, FIG. 6A shows a top-down view of horticulture light system 601. Horticulture light system 601 is representative of a mechanical grow apparatus with a plurality of lights and components to control mechanical and electrical aspects thereof. Horticulture light system 601 includes a frame made up of two center pieces 605 and four outer pieces 610, extrusion components 615, LED boards 620 (on an underneath side of extrusion components 615 with respect to the view shown), heatsink fins 625, light director 630, supplemental connector boards 635, primary connector boards 640, drivers 645, controller 650, and power supply 655.

Center pieces 605 and outer pieces 610 include metal elements coupled to outer portions of extrusion components 615 that make up a frame structure of horticulture light system 601. Center pieces 605 and outer pieces 610 are coupled to such outer portions in positions perpendicular to the components to hold the components together. Horticulture light system 601 includes two of center pieces 605 and four of outer pieces 610. One of center pieces 605 and two of outer pieces 610 can make up one side of the frame of horticulture light system 601, and the other one of center pieces 605 and two other ones of outer pieces 610 can make up a second side of the frame. Together, the sides of the frame can hold extrusion components 615 in place. Center pieces 605 and outer pieces 610 may be made out of a metal, aluminum, an alloy, or any other similar material. Alternatively, center pieces 605 and outer pieces 610 may be made out of a plastic or other material. Further, portions of center pieces 605 and outer pieces 610 may be pivotally coupled together with screws, nuts, bolts, fasteners, or another type of coupling mechanism. Such coupling may allow the outer pieces 610 to be articulated inward and/or outward to control the direction of illumination from LED board 620.

Extrusion components 615 include a plurality of support bars or beams coupled between center pieces 605 and outer pieces 610. Each of extrusion components 615 can be affixed between two of center pieces 605 or two of outer pieces 610. On one side of extrusion components 615, such as a side underneath the visible, top-side of extrusion components 615 illustrated in FIG. 6A, extrusion components 615 can include LED boards 620. Each of LED boards 620 can include a plurality of LED lights capable of producing light in a variety of channels of light spectra. The channels produced by LED boards 620 can be selectively controlled by controller 650 via driver 645, primary connector boards 640, and supplemental connector boards 635.

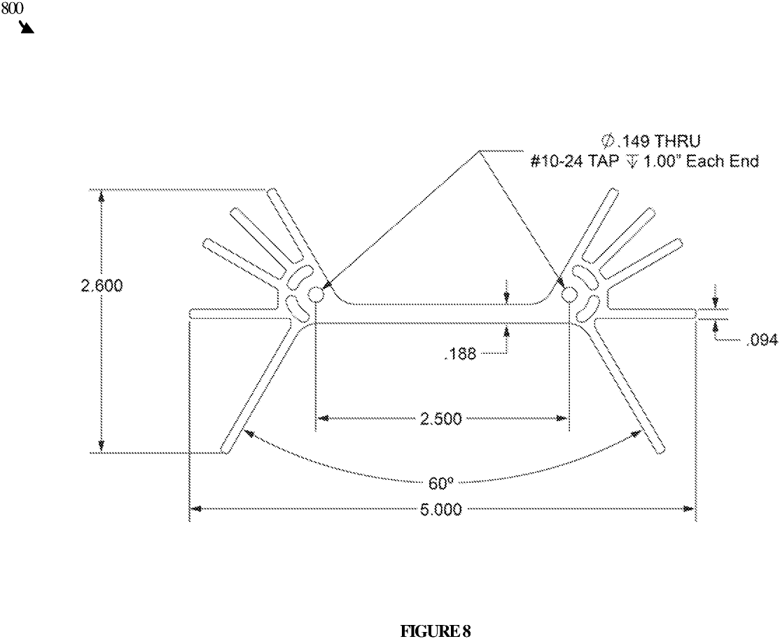

Heatsink fins 625 are also included between center pieces 605 and outer pieces 610 extending from extrusion components 615. Heatsink fins 625 provide heat dissipation and distribution for components of horticulture light 601. Further discussion about heatsink fins 625 may be found in the discussion of FIG. 8 below.

Light directors 630 are further included on outer portions of center pieces 605 and outer pieces 610. Light directors 630 include knobs, or other physical components, that can direct one or more components of horticulture light 601 in a way, such that light emissions from LED lights can be pointed in various directions.

Primary connector boards 640 and supplemental connector boards 635 are included on extrusion components 615. For example, each of extrusion components 615 can include one of primary connector boards 640 and two of supplemental connector boards 635. Primary connector boards 640 and supplemental connector boards 635 may include electrical components and connection mechanisms configured to provide coupling, power, and instructions (control of LED boards 620) to LED boards 620. For example, LED boards 620 can be individually coupled, electrically and physically, to ones of either primary connector boards 640 and supplemental connector boards 635. Primary connector boards 640 and supplemental connector boards 635 may be provided power and instructions via drivers 645.

Drivers 645 are included to provide power and instructions from controller 650 and power supply 655 to ones of primary connector boards 640 and supplemental connector boards 635. To do so, each of drivers 645 can be operatively coupled to one of primary connector boards 640. Then, primary connector boards 640 can provide the power and instructions to corresponding ones of supplemental connector boards 635 to control corresponding ones of LED boards 620. Horticulture light system 601 may include three of drivers 645. However, any number of drivers 645 can be included to provide the power and instructions downstream to primary connector boards 640.

Controller 650 is included to provide instructions based on a grow recipe (e.g., such as a grow recipe created by recipe creation engine 105 of FIG. 1). Controller 650 is representative of a processing system capable of implementing grow recipes as described herein. In some examples, controller 650 may include general purpose hardware, such as a microprocessor, capable of executing software and/or firmware that embodies the logic of a grow recipe. Controller 650 may be implemented within a single processing device, but it may also be distributed across multiple processing devices or subsystems that cooperate in executing instructions. In other examples, controller 650 may include fixed-purpose hardware capable of implementing grow recipes. Examples of fixed-purpose hardware include integrated circuits (ICs), application specific integrated circuits (ASICs), logic devices, and other such circuitry, as well as any combination or variation thereof.

Controller 650 can obtain a grow recipe to be implemented by horticulture light system 601 via a communication link between controller 650 and a client device (e.g., client device 110 of FIG. 1). Then, controller 650 can provide instructions based on the grow recipe to drivers 645 for implementation of the grow recipe.

Power supply 655 is included to provide power to the components of horticulture light system 601. For example, power supply 655 can include a power supply unit including various electronic circuits and components, one or more batteries, or the like.

Referring next to FIG. 6B, FIG. 6B includes a side view of horticulture light system 601. This illustration shows one of center pieces 605, two of outer pieces 610, light directors 630, and light emissions 660. In this illustration, portions of horticulture light system 601 (e.g., outer pieces 610), can be positioned such that LED boards 620 (not shown) can be angled towards a point directly below center pieces 605. Center pieces 605 and outer pieces 610 are pivotally coupled to each other, which allows outer pieces 610 to rotate about an axis with respect to center pieces 605. Further, in this configuration or other configurations, light directors 630 can be rotated about an axis to point light emissions 660 in various directions. In this example, light directors 630 are positioned in ways such that light emissions 660 are directed in a concentrated manner towards the point directly below center pieces 605.

FIG. 6C also illustrates a side view of horticulture light system 601. This illustration shows one of center pieces 605, two of outer pieces 610, light directors 630, and light emissions 660. In this illustration, portions of horticulture light system 601 (e.g., outer pieces 610), can be positioned such that LED boards 620 (not shown) can be angled towards a point directly below center pieces 605. Center pieces 605 and outer pieces 610 are pivotally coupled to each other, which allows outer pieces 610 to rotate about an axis with respect to center pieces 605. Further, in this configuration or other configurations, light directors 630 can be rotated about an axis to point light emissions 660 in uniform directions. In this example, light directors 630 are positioned in ways such that light emissions 660 are directed in a concentrated and evenly distributed manner towards the point directly below center pieces 605.

Next, in FIG. 6D, a side view of horticulture light system 601 is illustrated. FIG. 6D includes a view of one of center pieces 605 and two of outer pieces 610 of the frame, light directors 630, and light emissions 660. In this aspect, center pieces 605 and outer pieces 610 may be configured in parallel with each other, or directly horizontal. In this way, light emissions 660 can be pointed in another variation.

Lastly, in FIG. 6E, an exemplary one of extrusion components 615 is illustrated. In this example, the extrusion component can be made of several extrusion components (e.g., linked or coupled together) to expand the length of horticulture light system 601, and consequently, the light emission coverage of horticulture light system 601. More specifically, this one of extrusion components 615 may be thirty-two feet in length. In various instances, extrusion components 615 extend to four feet in length. Thus, this exemplary one of extrusion components 615 may include eight components coupled together.

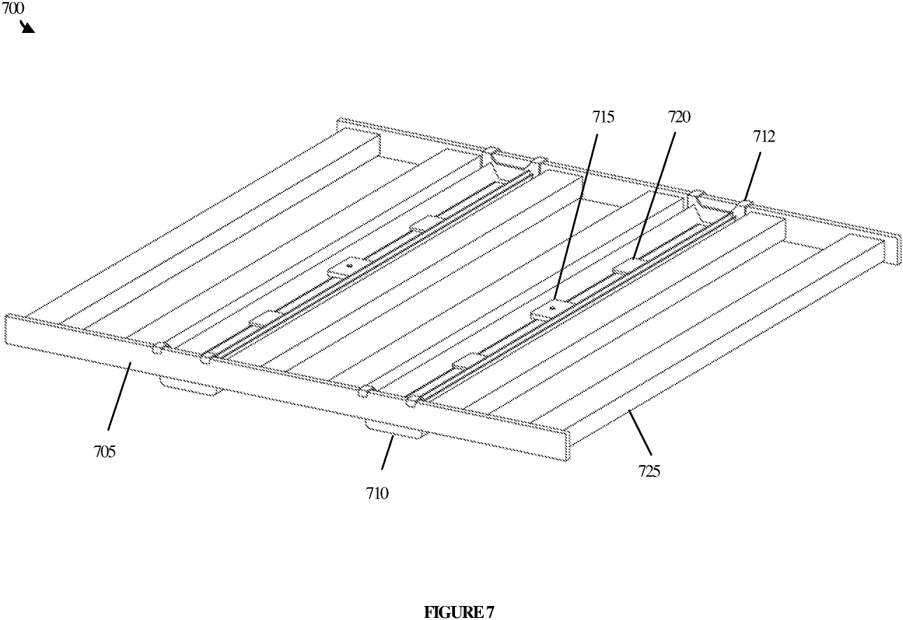

FIG. 7 illustrates an example configuration of a horticulture light system 700 in accordance with an embodiment. Horticulture light system 700 of FIG. 7 includes a frame made of two outer pieces 705, extrusion components 710, coupling mechanisms 712, primary connector boards 715, supplementary connector boards 720, and extrusion components 725.

Horticulture light system 700 may include two of outer pieces 705 to make up a frame that provides structural support for horticulture light system 700. Each of outer pieces 705 can be positioned in parallel with each other. Extrustion components 710 and 725 can be affixed to or coupled with the frame. In various examples, extrusion components 710 and 725 are positioned perpendicularly with respect to outer pieces 705, and they are affixed or coupled to inner portions of outer pieces 705.

Extrusion components 710 represent components of horticulture light system 610 (extrusion components 615) that provide structure and light for horticulture light system 700. Extrusion components 710 can include LED boards and LED lights capable of producing lights in a variety of channels of light spectra. The channels produced by LED boards 710 can be selectively controlled by a controller of horticulture light system 700 (not shown) via primary connector boards 715 and supplementary connector board 720, which are also included in or on extrusion component 710. Primary connector boards 715 and supplemental connector boards 720 may include electrical components and connection mechanisms configured to provide coupling, power, and instructions to extrusion components 710. For example, LED boards of extrusion components 710 can be individually coupled to ones of either primary connector boards 715 or supplemental connector boards 720.

Extrusion components 710 can be attached or affixed to a frame of horticulture light system 700 via coupling mechanisms 712. Coupling mechanisms 712 can include clamps, latches, or other physical elements capable of affixing extrusion components 710 to outer pieces 705 of the frame. However, in other examples, other types of couplings can be used. In this way, extrusion components 710, and elements thereof (e.g., LED lights, primary connector boards 715, supplemental connector boards 720), can be removed, replaced, repositioned, and the like on horticulture light system 700, or any other horticulture light system.

In various examples, extrusion components 725 represent support beams and lighting elements of horticulture light system 700 different from extrusion components 710. For instance, extrusion components 725 can include lighting components that are not under the control of primary connector boards 715 and supplemental connector boards 720 like extrusion components 710. More specifically, extrusion components 725 may represent a legacy horticulture structure and lighting components, whereas extrusion components 710 may represent structure and lighting components controllable by processes described herein.

FIG. 8 illustrates an example heatsink component of a light system used in an embodiment. FIG. 8 includes heatsink 800 and various measurements and features thereof.

Heatsink 800 is included in a horticulture light system to dissipate heat produced by components of the system. Heatsink 800 may be a made of copper, aluminum, or another element with thermal conductivity capable of dissipating heat from the horticulture light system. Heatsink 800 can include two sets of tips, or fins, that can be included to dissipate heat, captured by heatsink 800, from other components of a horticulture light system. As illustrated, a portion of a set of fins of heatsink 800 can be pointed in directions outward with respect to a middle portion of heatsink 800, a fin of a set of fins can be pointed horizontally outwards from the middle portion of heatsink 800, or in parallel with the middle portion of heatsink 800, and another fin of a set of fins can be pointed a direction opposite from the direction the plurality of fins is pointing. The height of each set of fins may be 2.6 inches. The sets of the fins of heatsink 800 may be located on opposite sides of the middle portion of heatsink 800 with respect to each other. More specifically, one set of fins may be located on one end of the middle portion, and the other set of fins may be located 2.5 inches away on another end of the middle portion. It follows that the middle portion may be 2.5 inches in width.

The length of heatsink 800 may be 5.0 inches from one end to the other end. Further, the thickness of a middle component of heatsink 800 may be 0.188 inches. The sets of tips of heatsink 800 can provide an opening of 60 degrees. It may be appreciated, however, that the size, dimensions, composition, positioning, and the like of heatsink 800 and components thereof may be different.

In various embodiments, heatsink 800 may function as an extrusion component to which LED boards can be coupled. For example, heatsink 800 may represent one of extrusion components 615 of horticulture light system 601 of FIG. 6A. In this way, LED boards can be affixed to a bottom side of the middle portion of heatsink 800 positioned in between the sets of fins. Accordingly, illumination from LEDs of the LED boards can be columnized in a 60-degree window towards an area of a horticulture grow facility.

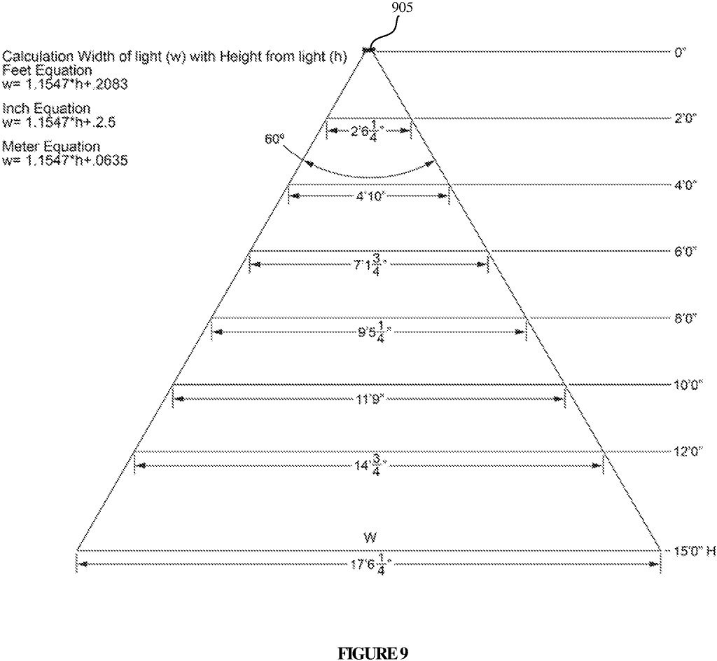

FIG. 9 illustrates example configurations of a light system in accordance with an embodiment. FIG. 9 includes various combinations of light distribution with respect to heights and widths from a light system 905 of a horticulture light system, such as horticulture light system 601 of FIG. 6A.

FIG. 9 includes light system 905. Light system 905 is representative of a plurality of LED lights onboard a horticulture light system. The LED lights can emit light of various channels of light spectra. The intensity at which the LED lights can emit such light may vary depending on the power provided to the LED lights. Regardless, the LED lights can be directed towards a subject (e.g., a plant) and can emit light in a 60 degree range. This range may be determined by dimensions and positioning of heatsink fins onboard the horticulture light system, such as heatsink 800 of FIG. 8. When light system 905 is two feet above a subject, light system 905 can emit light spanning 2′6.25″ in width. When light system 905 is four feet above a subject, light system 905 can emit light spanning 4′ 10″ in width. When light system 905 is six feet above a subject, light system 905 can emit light spanning 7′ 1.75″ in width. When light system 905 is eight feet above a subject, light system 905 can emit light spanning 9′5.25″ in width. When light system 905 is ten feet above a subject, light system 905 can emit light spanning 11′9″ in width. When light system 905 is twelve feet above a subject, light system 905 can emit light spanning 14′ 0.075″ in width. And when light system 905 is fifteen feet above a subject, light system 905 can emit light spanning 17′6.25″ in width. It follows that light system 905 can emit light at wider ranges and within 60 degrees the further the subject is placed away from light system 905. The following equation may be used to calculate the width (in feet), where “w” is the width of light coverage and “h” is the height, or vertical distance, from light system 905:

$$\text{w = 1} \text{.1547*h + 0} \text{.2083} \text{.}$$

It may be appreciated that the angle at which light system 905 distributes light may vary, which may cause other dimensions to vary as well.

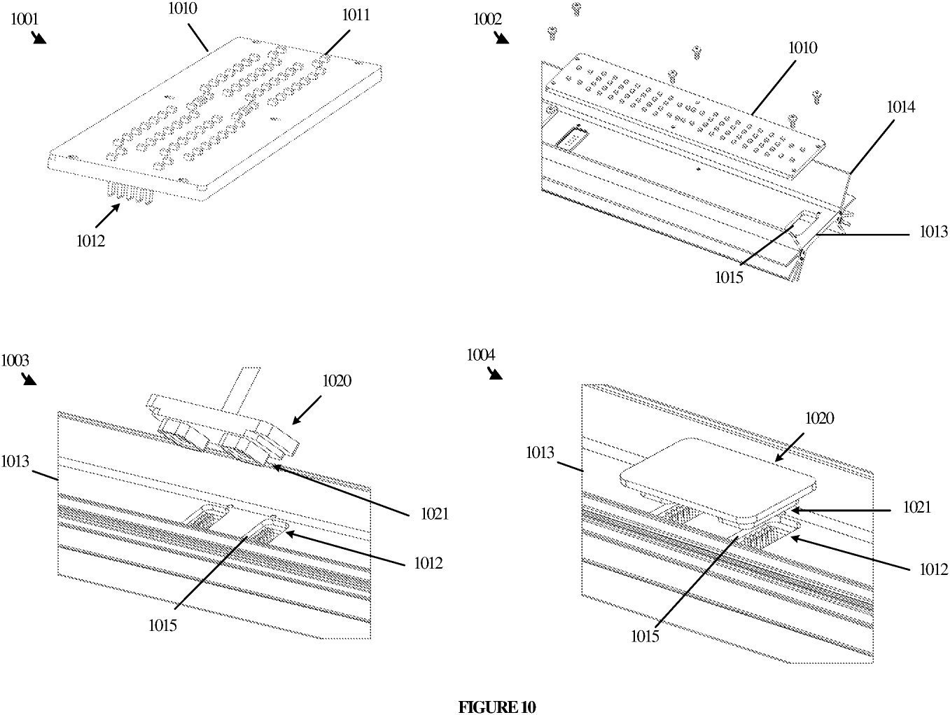

FIG. 10 illustrates example aspects of an LED board and a portion of a light structure in accordance with an embodiment. FIG. 10 includes aspects 1001, 1002, 1003, and 1004. Each aspect demonstrates one or more components and features of a horticulture light system, such as horticulture light system 601 of FIG. 6A.

Aspect 1001 shows LED board 1010, LEDs 1011, and board plug 1012. LED board 1010 can include a plurality of LEDs 1011, each of which may emit light in various channels of light spectra. LEDs 1011 may emit only certain spectra of light. For example, some of LEDs 1011 may be configured to emit deep-red and far-red light, some of LEDs 1011 may be configured to emit UV light, and some of LEDs 1011 may be configured to emit light in the PAR channel. However, in other cases, LEDs 1011 may be able to emit light of any spectra. Board plug 1012 is included to couple LED board 1010 to a connector board of the horticulture light system, such as connector board 1020 of aspect 1003. Board plug 1012 can function to obtain power and instructions from a connector board to allow LEDs 1011 to operate.

Aspect 1002 shows LED board 1010, extrusion component 1013, heatsinks 1014, and hole 1015. Extrusion component 1013 is representative of one support beam of many of a horticulture light system. Each of extrusion component 1013 can provide housing for one or more of LED board 1010, connector boards, and heatsinks 1014. LED board 1010 can be affixed or coupled to extrusion component 1013 by one or more screws, nuts, bolts, or other fasteners. Board plug 1012 of LED board 1010 (not shown in aspect 1002) can fit through corresponding ones of hole 1015, such that when LED board 1010 is affixed to extrusion component 1013, LED board 1010 sits flush with extrusion component 1013.

When coupled together, LEDs 1011 of LED board 1010 can emit light at a subject of a horticulture area (not shown). While emitting light, LEDs 1011 and other electronic components of the horticulture light system may produce heat. Heatsinks 1014 are provided to dissipate such heat to reduce a risk of overheating. Heatsinks 1014 may include various wing-like features that not only provide dissipation, but also direct light emissions from LEDs 1011 to a targeted area of the horticulture area.

Aspect 1003 shows a view of extrusion component 1013 where board plug 1012 is inserted into hole 1015. Aspect 1003 also shows connector board 1020, which includes connector plug 1021. Connector board 1020 is representative of an electronic component configured to receive power and instructions from a driver and/or a controller of a horticulture light system (neither shown) and provide such power and instructions to LED board 1010 and LEDs 1011 thereof via a physical and electrical connection between board plug 1012 and connector plug 1021. Connector board 1020 may include be exemplified as a primary connector board or supplementary connector board, such as ones in FIG. 6A.

Aspect 1004 shows another view of extrusion component 1013 where connector plug 1021 of connector board 1020 is being physically and electrically coupled to board plug 1012 of LED board 1010 (not shown) through hole 1015. To physically and electrically couple connector plug 1021 to board plug 1012, the electrical and physical components of one can be inserted into sockets of another. For example, the connector plug 1021 and board plug 1012 can be pressed, snapped, or otherwise pushed together to create a connection between the electrical and physical components. Once coupled together, connector board 1020 can provide signals, such as instructions and power, to LED board 1010 via respective plugs.

It may be appreciated that various components illustrated in aspects 1001, 1002, 1003, and 1004, among other components of horticulture light systems described herein, can be replaced in the event of component failure or a desire to upgrade the components. For example, in the event that one or more LED boards (e.g., LED board 1010) fails (i.e., stops emitting light in a desired spectra, at a desired intensity, or entirely), the one or more LED boards can be removed from the horticulture light system, by a non-technical person, and replaced without replacing the entire horticulture light system.

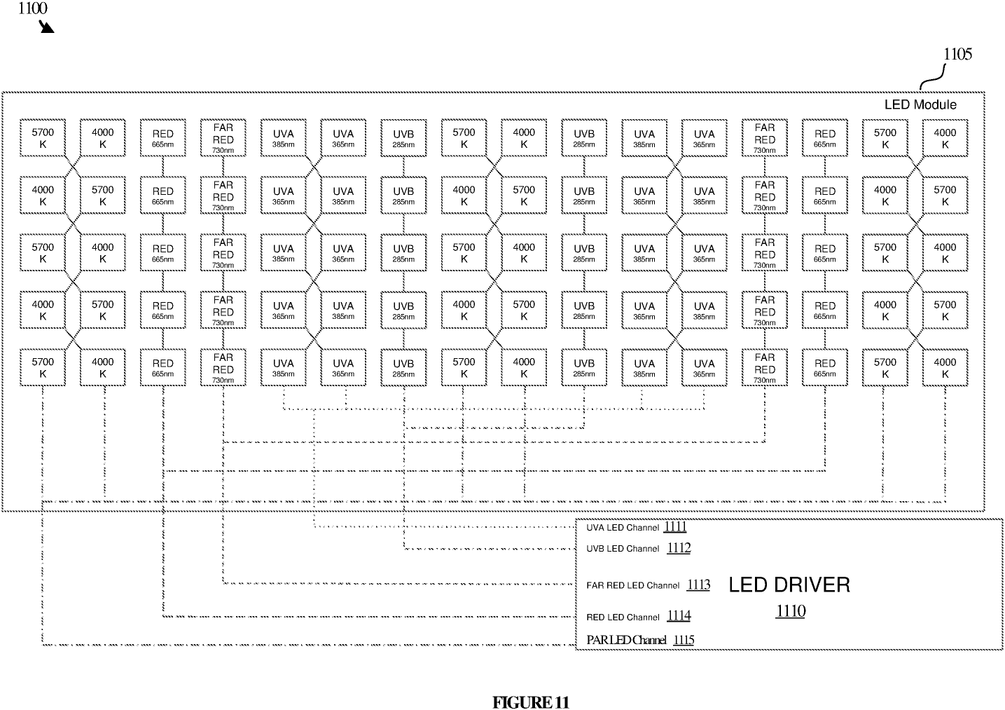

FIG. 11 illustrates an example LED module and LED control system in accordance with an embodiment. FIG. 11 shows aspect 1100, which includes LED module 1105 and LED driver 1110. Components of aspect 1100 may be included in a horticulture light system, such as horticulture light system 601 of FIG. 6A and can be configured to operate according to a grow recipe produced by a recipe creation service, such as recipe creation service 105 of FIG. 1 and grow recipe creation engine 310 of FIG. 3.

LED module 1105 is representative of a LED board (e.g., LED board 1010 of FIG. 10) that includes a plurality of LED lights. The LED lights can emit light in a variety of channels of spectra. For example, the channels of light spectra include an ultraviolet-A (UV-A) channel, an ultraviolet-B (UV-B) channel, a photosynthetically active radiation (PAR) channel, a deep-red channel, and a far-red channel. As illustrated in aspect 1100, the LEDs of LED module 1105 include 4000K LEDs, 5700K LEDs, red LEDs, far-red LEDs, UV-A LEDs, and UV-B LEDs. Each of the LEDS can be configured to produce light of a wavelength in a respective channel.

Each set of LEDs can be connected, via wiring for example, to LED driver 1110. For instance, the 4000K LEDs and 5700K LEDs can be connected to PAR LED channel 1115 of LED driver 1110, the red LEDs can be connected to RED LED channel 1114, the far-red LEDs can be connected to FAR RED LED channel 1113, the UV-B LEDs can be connected to UVB LED channel 1112, and the UV-A LEDs can be connected to UVA LED channel 1111 of LED driver 1110. LED driver 1110 may be coupled with a controller of a horticulture light system (not shown), which can be configured to provide instructions for control of the LEDs of LED module 1105 based on a grow recipe. For example, the controller may instruct LED driver 1110 to turn certain LEDs on or off at various times during a day. LED driver 1110 can then control the LED lights per the instructions via respective channels. Examples of instructions may include power on or off, intensity (e.g., low, medium, high), color/wavelength, and the like. LED driver 1110 can turn any combination of the LEDs on/off at varying intensities and at varying times. Thus, any variation or combination of light spectra and timing of light emissions can be contemplated.

While some examples provided herein are described in the context of an imaging subsystem, image sensor, layer, or environment, the pixel defect detection and correction systems and methods described herein are not limited to such embodiments and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
at a client device:
establishing a connection to a recipe creation service;
providing, to the recipe creation service, harvest data corresponding to a completed harvest cycle of a plant and comprising results and parameters of the completed harvest cycle; and
providing, to the recipe creation service, one or more inputs corresponding to an upcoming harvest cycle of the plant;
at the recipe creation service:
generating a grow recipe for the upcoming harvest cycle of the plant based on the harvest data and the one or more inputs; and
providing the grow recipe to the client device; and
at the client device:
providing the grow recipe to a mechanical grow apparatus comprising LED lights and a controller, wherein the controller is configured to control the LED lights for the upcoming harvest cycle based on the grow recipe.

2. The method of claim 1, wherein the grow recipe comprises a lighting schedule including time intervals and channels of light spectra of the LED lights, wherein, in the lighting schedule, one or more of the channels of the light spectra correspond to one or more time intervals of the time intervals.

3. The method of claim 2, wherein the channels of the light spectra of the LED lights include an ultraviolet-B (UV-B) channel, an ultraviolet-A (UV-A) channel, a photosynthetically active radiation (PAR) channel, a deep-red channel, and a far-red channel.

4. The method of claim 1, wherein the one or more inputs indicate one or more desired outcomes of the upcoming harvest cycle including at least one among a desired potency, a desired size, and a desired flavor of the plant.

5. The method of claim 1, wherein the results of the completed harvest cycle comprise one among a produced potency of the plant, a produced size of the plant, and a produced flavor of the plant.

6. The method of claim 1, wherein the results include lab-certified results of the completed harvest cycle.

7. The method of claim 1, wherein the parameters of the completed harvest cycle comprise environmental parameters of the completed harvest cycle and artificial parameters of the completed harvest cycle.

8. The method of claim 7, wherein the environmental parameters comprise a type of soil used for the completed harvest cycle, an amount of sunlight exposure during the completed harvest cycle, and an amount of carbon dioxide exposure during the completed harvest cycle.

9. The method of claim 7, wherein the artificial parameters comprise light settings of the mechanical grow apparatus used during the completed harvest cycle including channels of light spectra of the LED lights and durations of use of the LED lights at corresponding channels of the channels of the light spectra.

10. A recipe creation service, comprising:
a harvest database comprising harvest data corresponding to a completed harvest cycle of a plant, wherein the harvest data comprises results and parameters of the completed harvest cycle;
a recipe creation engine configured to:
obtain the harvest data from the harvest database;
obtain one or more inputs corresponding to an upcoming harvest cycle of the plant;
generate a grow recipe for the upcoming harvest cycle of the plant based on the harvest data and the one or more inputs; and
a provisioning engine configured to provide the grow recipe to a client device, wherein the client device controls operations of a mechanical grow apparatus having LED lights.

11. The recipe creation service of claim 10, wherein the grow recipe comprises a lighting schedule including time intervals and channels of light spectra of the LED lights of the mechanical grow apparatus, wherein, in the lighting schedule, one or more of the channels of the light spectra correspond to one or more time intervals of the time intervals.

12. The recipe creation service of claim 11, wherein the channels of the light spectra of the LED lights include an ultraviolet-B (UV-B) channel, an ultraviolet-A (UV-A) channel, a photosynthetically active radiation (PAR) channel, a deep-red channel, and a far-red channel.

13. The recipe creation service of claim 10, wherein the one or more inputs indicate one or more desired outcomes of the upcoming harvest cycle including at least one among a desired potency, a desired size, and a desired flavor of the plant.

14. The recipe creation service of claim 10, wherein the results of the completed harvest cycle comprise one among a produced potency of the plant, a produced size of the plant, and a produced flavor of the plant.

15. The recipe creation service of claim 10, wherein the parameters of the completed harvest cycle comprise environmental parameters of the completed harvest cycle and artificial parameters of the completed harvest cycle.

16. The recipe creation service of claim 15, wherein the environmental parameters comprise a type of soil used for the completed harvest cycle, an amount of sunlight exposure during the completed harvest cycle, and an amount of carbon dioxide exposure during the completed harvest cycle, and the artificial parameters comprise light settings of the mechanical grow apparatus used during the completed harvest cycle including channels of light spectra of the LED lights and durations of use of the LED lights at corresponding channels of the channels of the light spectra.

17. A client device, comprising:
an interface;
a memory; and
a grow recipe execution engine;
wherein the interface is configured to:
obtain, from a recipe creation service, a grow recipe for a harvest cycle of a plant, wherein the grow recipe comprises a lighting schedule including time intervals and channels of light spectra of LED lights of a mechanical grow apparatus, and wherein one or more of the channels of the light spectra correspond to one or more time intervals of the time intervals; and
store the grow recipe on the memory; and
wherein the grow recipe execution engine is configured to:
obtain the grow recipe from the memory; and
provide the grow recipe to the mechanical grow apparatus to perform the harvest cycle using the grow recipe.

18. The client device of claim 17, wherein the channels of the light spectra of the LED lights include an ultraviolet-B (UV-B) channel, an ultraviolet-A (UV-A) channel, a photosynthetically active radiation (PAR) channel, a deep-red channel, and a far-red channel.

19. The client device of claim 17, wherein the mechanical grow apparatus comprises a frame, a power supply, the LED lights, and a controller.

20. The client device of claim 19, wherein the controller of the mechanical grow apparatus is configured to control operations of the LED lights including intensity of the LED lights and the light spectra of the LED lights according to the grow recipe.
